(19) United States
(12) Patent Application Publication
(10) Pub. No.: US 2022/0399779 A1
(43) Pub. Date: Dec. 15, 2022

(54) DRIVE UNIT

(71) Applicant: EXEDY Corporation, Osaka (JP)

(72) Inventor: Yoshihiro MATSUOKA, Osaka (JP)

(21) Appl. No.: 17/740,717

(22) Filed: May 10, 2022

(30) Foreign Application Priority Data
Jun. 10, 2021 (JP) 2021-097141

(51) Int. Cl. H02K 7/10; B60K 1/00; H02K 7/00

(52) U.S. Cl. CPC H02K 7/10; B60K 1/00; H02K 7/006; B60K 2001/001

(57) ABSTRACT

A drive unit is disclosed. The drive unit includes an electric motor and a torque converter. The electric motor is configured to drive a drive wheel through the torque converter. The electric motor has a characteristic that an output torque increases with increase in rotational speed within a rotational speed range from stoppage to a predetermined rotational speed.

### CROSS-REFERENCE TO RELATED APPLICATIONS

This application claims priority to Japanese Patent Application No. 2021-097141 filed Jun. 10, 2021. The entire contents of that application are incorporated by reference herein in their entirety.

### TECHNICAL FIELD

The present invention relates to a drive unit.

### BACKGROUND ART

In well-known electric cars, a torque, outputted from an electric motor, is transmitted to drive wheels through a reducer and a differential gear. For example, in an electric car disclosed in Japan Laid-open Patent Application Publication No. 2013-60996, the reducer is directly connected to the electric motor, and a torque is transmitted from the reducer to the drive wheels through the differential gear. It should be noted that an embedded magnet synchronous motor is used as the electric motor serving as a drive source in the electric car. The embedded magnet synchronous motor can exert the maximum torque from stoppage.

It has been demanded to enhance a driving force in such an electric car as described above. In view of this, it is an object of the present invention to provide a drive unit enabling enhancement in driving force.

### BRIEF SUMMARY

A drive unit according to an aspect of the present invention includes a torque converter and an electric motor. The electric motor is configured to drive a drive wheel through the torque converter. The electric motor has a characteristic that an output torque increases with increase in rotational speed within a rotational speed range from stoppage to a predetermined rotational speed.

According to this configuration, a torque is outputted from the electric motor toward the drive wheel through the torque converter; hence, a driving force can be enhanced. In the present drive unit, the electric motor outputs the torque to the torque converter; hence, a load torque is quite small when the electric motor is in stoppage. Because of this, unlike well-known electric motors used in electric cars, the electric motor in the present drive unit is not required to output the maximum torque from stoppage. In view of this, the electric motor in the present drive unit is configured to have the characteristic that the output torque increases with increase in rotational speed within the rotational speed range from stoppage to the predetermined rotational speed. Thus, the present drive unit uses the electric motor having the characteristic configured as appropriately as possible.

Preferably, the electric motor has a characteristic that the output torque reduces with increase in rotational speed within a higher rotational speed range than the predetermined rotational speed.

Preferably, the electric motor includes a magnet-free rotor and a stator. According to this configuration, the electric motor is of a magnet-free type; hence, it is not required to reduce induced voltage in high-speed rotation. As a result, field-weakening control can be made unnecessary.

Overall, according to the present invention, enhancement in driving force is enabled.

### BRIEF DESCRIPTION OF THE DRAWINGS

FIG. 1 is a schematic diagram of a drive unit.

FIG. 2 is a chart showing characteristics of an electric motor.

FIG. 3 is a cross-sectional view of a torque converter.

FIG. 4 is a cross-sectional view of a type of impeller hub.

FIG. 5 is a cross-sectional view of another type of impeller hub.

FIG. 6 is a close-up view of a power output part.

FIG. 7 is a close-up view of the power output part.

FIG. 8 is a close-up view of the power output part.

FIG. 9 is a cross-sectional view of the drive unit shown for indicating a first cooling flow pathway.

FIG. 10 is a cross-sectional view of a sidewall portion of a type of torque converter casing.

FIG. 11 is a cross-sectional view of a sidewall portion of another type of torque converter casing.

FIG. 12 is a schematic diagram of a drive unit according to a modification.

### DETAILED DESCRIPTION

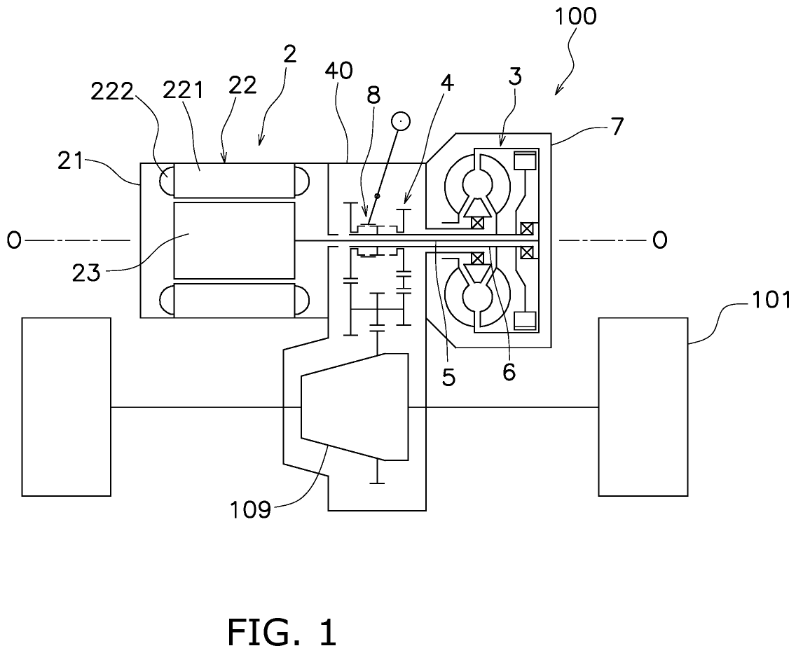

A drive unit according to the present preferred embodiment will be hereinafter explained with reference to drawings. FIG. 1 is a schematic diagram of the drive unit according to the present preferred embodiment. It should be noted that in the following explanation, the term “axial direction” refers to an extending direction of a rotational axis O for both an electric motor 2 and a torque converter 3. On the other hand, the term “circumferential direction” refers to a circumferential direction of an imaginary circle about the rotational axis O, whereas the term “radial direction” refers to a radial direction of the imaginary circle about the rotational axis O.

### Drive Unit 100

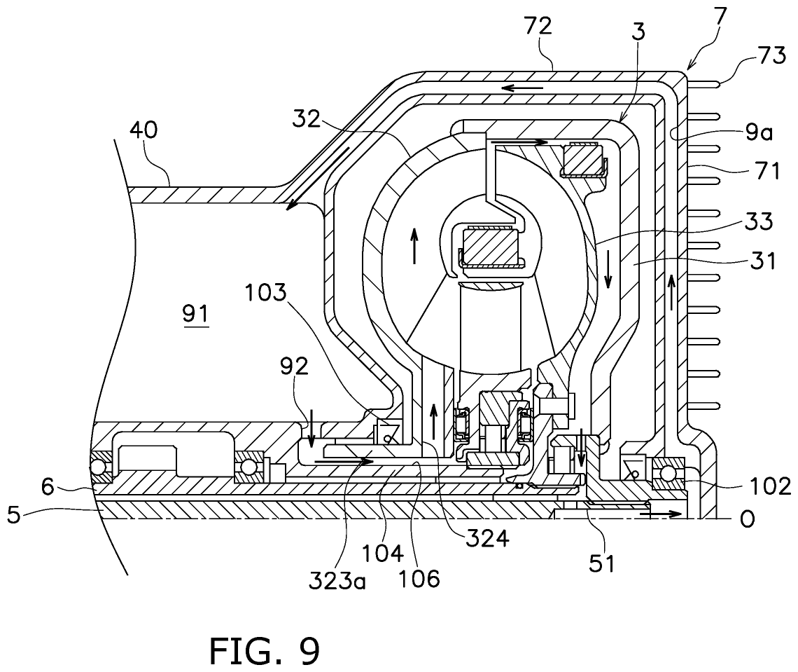

As shown in FIG. 1, a drive unit 100 is a unit for driving drive wheels 101. The drive unit 100 includes the electric motor 2, the torque converter 3, a power output part 4, a switch mechanism 8, an input shaft 5, an output shaft 6, a torque converter casing 7, and a first cooling flow pathway 9a (see FIG. 9). The drive unit 100 is installed in, for instance, an electric car.

### Electric Motor 2

The electric motor 2 is configured to drive the drive wheels 101 through the torque converter 3. In other words, a torque, outputted from the electric motor 2, is transmitted to the drive wheels 101 through the torque converter 3.

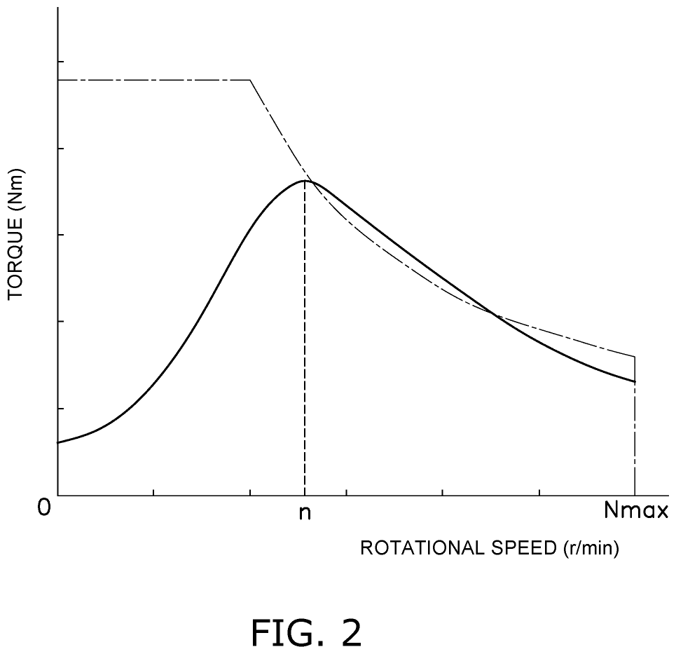

FIG. 2 is a chart showing characteristics of the electric motor 2 (relation between rotational speed and torque). It should be noted that in FIG. 2, a solid line is a torque curve indicating the characteristics of the electric motor 2 in the present preferred embodiment. In FIG. 2, a dashed-dotted line is a torque curve indicating characteristics of an electric motor used as a drive source in a well-known electric car.

As shown with the solid line in FIG. 2, the electric motor 2 has a characteristic that an output torque increases with increase in rotational speed within a rotational speed range from stoppage (rotational speed 0) to a predetermined rotational speed n. In other words, the electric motor 2 does not output the maximum torque from stoppage. It should be noted that in the electric motor 2, the magnitude of a torque at the rotational speed 0 is less than or half that of the maximum torque.

Besides, the electric motor 2 has a characteristic that the output torque reduces with increase in rotational speed within a higher rotational speed range than the predetermined rotational speed n. The electric motor 2 outputs the maximum torque at the predetermined rotational speed n. It should be noted that the predetermined rotational speed n is, for instance, 20% to 40% of the maximum rotational speed Nmax of the electric motor 2, albeit not particularly limited thereto.

As shown in FIG. 1, the electric motor 2 includes a motor casing 21, a stator 22, and a rotor 23. In the present preferred embodiment, the electric motor 2 is of a so-called inner rotor type. The motor casing 21 is non-rotatable, while being fixed to a body frame of a vehicle or so forth.

The stator 22 is fixed to the inner peripheral surface of the motor casing 21. The stator 22 is non-rotatable. The stator 22 includes a stator core 221 and a coil 222. The stator core 221 is formed by laminating a plurality of electromagnetic steel plates. The coil 222 is wound about the stator core 221. When described in detail, the coil 222 is wound about teeth of the stator core 221.

The rotor 23 is rotated about the rotational axis O. The rotor 23 is disposed radially inside the stator 22. The rotor 23 does not include any permanent magnet. For example, the rotor 23 can be made in form of a bucket rotor. The electric motor 2 can be made in form of an induction motor. It should be noted that as described below, the rotational direction of the electric motor 2 remains unchanged regardless of forward movement and backward movement of the vehicle. Because of this, the electric motor 2 is rotated only in a forward rotational direction without being rotated in a reverse rotational direction.

### Torque Converter 3

The torque converter 3 is disposed axially apart from the electric motor 2 at an interval. The power output part 4 is disposed between the torque converter 3 and the electric motor 2. The electric motor 2, the power output part 4, and the torque converter 3 are axially aligned in this order.

The rotational axis O of the torque converter 3 is substantially matched with that of the electric motor 2. The torque converter 3 is a device to which power, outputted from the electric motor 2, is inputted. Then, the torque converter 3 amplifies the power (torque) inputted thereto from the electric motor 2 and outputs the amplified power to the power output part 4.

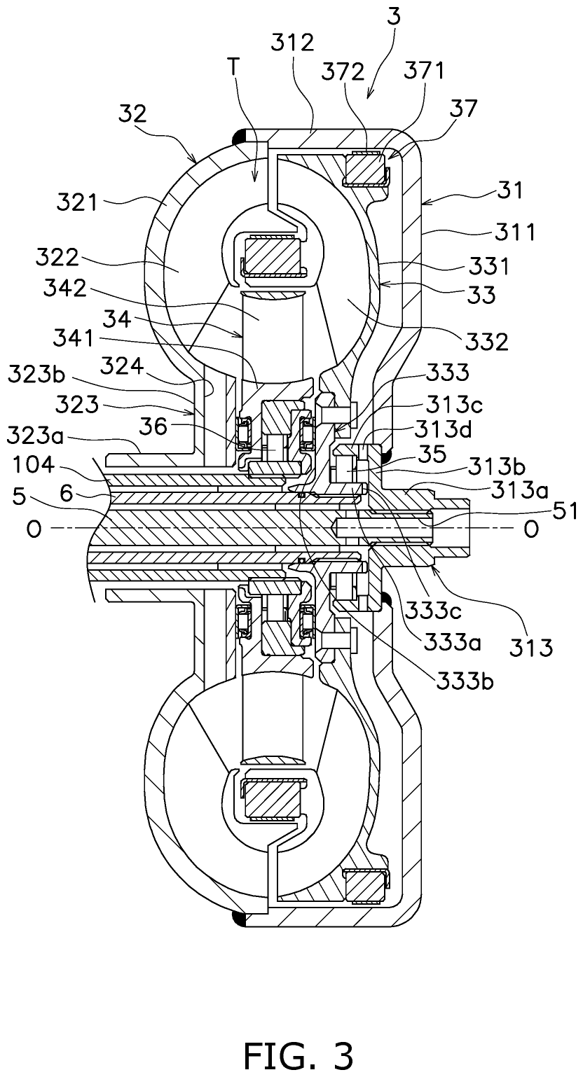

As shown in FIG. 3, the torque converter 3 includes a cover 31, an impeller 32, a turbine 33, a stator 34, and a one-way clutch 36. Besides, the torque converter 3 further includes a centrifugal clutch 37.

The torque converter 3 is disposed such that the impeller 32 faces the electric motor 2 (the left side in FIG. 3), whereas the cover 31 faces opposite to the electric motor 2 (the right side in FIG.

3). The torque converter 3 is accommodated in the interior of the torque converter casing 7. Hydraulic fluid is supplied to the interior of the torque converter 3. The hydraulic fluid is, for instance, hydraulic oil.

The cover 31 is a component to which the power, outputted from the electric motor 2, is inputted. The cover 31 is rotated by the power inputted thereto from the electric motor 2. The cover 31 is fixed to the input shaft 5 extending from the electric motor 2. For example, the cover 31 includes a spline hole to which the input shaft 5 is spline-coupled. Because of this, the cover 31 is unitarily rotated with the input shaft 5. The cover 31 is disposed to cover the turbine 33.

The cover 31 includes a disc portion 311, a cylindrical portion 312, and a cover hub 313. The disc portion 311 includes an opening in the middle thereof. The cylindrical portion 312 extends from the outer peripheral end of the disc portion 311 toward the electric motor 2. The disc portion 311 and the cylindrical portion 312 are provided as a single member integrated with each other.

The cover hub 313 is fixed to the inner peripheral end of the disc portion 311. In the present preferred embodiment, the cover hub 313 is provided as a different member separated from the disc portion 311. However, the cover hub 313 may be provided as a single member integrated with the disc portion 311.

The cover hub 313 includes a first boss portion 313a, a first flange portion 313b, and a protruding portion 313c. The first boss portion 313a, the first flange portion 313b, and the protruding portion 313c are provided as a single member integrated with each other.

The first boss portion 313a has a cylindrical shape and includes a spline hole. The input shaft 5 is spline-coupled to the first boss portion 313a. The first boss portion 313a is rotatably supported by the torque converter casing 7 through a bearing member 102. Because of this, the first boss portion 313a axially extends from the first flange portion 313b to the opposite side of the electric motor 2.

The first flange portion 313b extends radially outward from the first boss portion 313a. When described in detail, the first flange portion 313b extends radially outward from the electric motor 2-side end of the first boss portion 313a. The disc portion 311 is fixed to the outer peripheral end of the first flange portion 313b.

The protruding portion 313c axially extends from the first flange portion 313b. The protruding portion 313c extends toward the electric motor 2. The protruding portion 313c extends from the outer peripheral end of the first flange portion 313b. The protruding portion 313c has a cylindrical shape. The protruding portion 313c includes a plurality of through holes 313d. The hydraulic fluid is discharged from the torque converter 3 through the through holes 313d.

The impeller 32 is unitarily rotated with the cover 31. The impeller 32 is fixed to the cover 31. The impeller 32 includes an impeller shell 321, a plurality of impeller blades 322, an impeller hub 323, and a plurality of supply flow pathways 324.

The impeller shell 321 is fixed to the cover 31. The plural impeller blades 322 are attached to the inner surface of the impeller shell 321.

The impeller hub 323 is attached to the inner peripheral end of the impeller shell 321. It should be noted that in the present preferred embodiment, the impeller hub 323 is provided as a single member integrated with the impeller shell 321, but alternatively, may be provided as a different member separated from the impeller shell 321.

The impeller hub 323 includes a second boss portion 323a and a second flange portion 323b. The second boss portion 323a has a cylindrical shape and axially extends. The second boss portion 323a is rotatably supported by the torque converter casing 7 through a bearing member 103 (see FIG. 9). A stationary shaft 104 axially extends in the interior of the second boss portion 323a. It should be noted that the stationary shaft 104 has a cylindrical shape and the output shaft 6 axially extends in the interior of the stationary shaft 104. Besides, the stationary shaft 104 extends from, for instance, a transmission casing 40 or the torque converter casing 7. The stationary shaft 104 is non-rotatable.

The supply flow pathways 324 are provided in the impeller hub 323. When described in detail, the supply flow pathways 324 are provided in the second flange portion 323b. The supply flow pathways 324 extend radially outward from the inner peripheral surface of the impeller hub 323. Besides, the supply flow pathways 324 are opened to the interior of a torus T. It should be noted that the torus T is a space enclosed by the impeller 32 and the turbine 33.

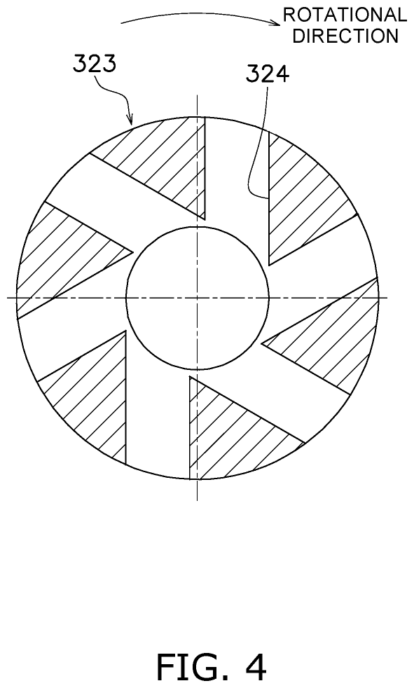

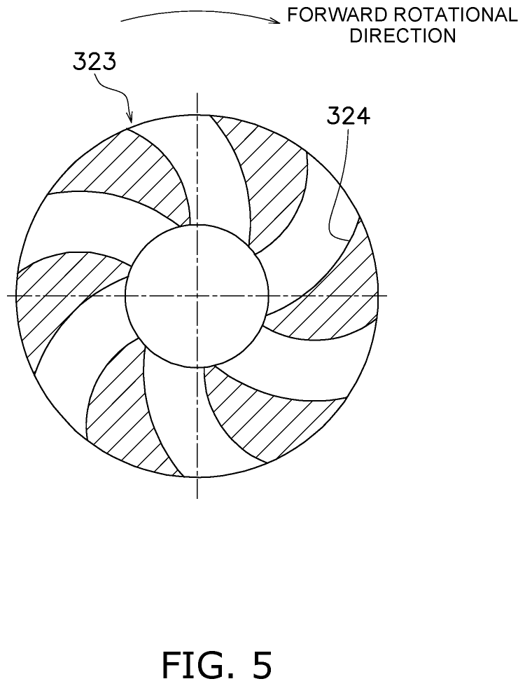

The supply flow pathways 324 are axially closed. In other words, the supply flow pathways 324 are through holes radially extending in the impeller hub 323. As shown in FIG. 4, the supply flow pathways 324 extend in a radial shape. The supply flow pathways 324 slant opposite to the rotational direction, while extending radially outward. It should be noted that the extending shape of each supply flow pathway 324 is not limited to a straight shape. For example, as shown in FIG. 5, each supply flow pathway 324 may extend in a curved shape.

As shown in FIG. 3, the turbine 33 is disposed opposite to the impeller 32. When described in detail, the turbine 33 is axially opposed to the impeller 32. The turbine 33 is a component to which the power is transmitted from the impeller 32 through the hydraulic fluid.

The turbine 33 includes a turbine shell 331, a plurality of turbine blades 332, and a turbine hub 333. The plural turbine blades 332 are fixed to the inner surface of the turbine shell 331.

The turbine hub 333 is fixed to the inner peripheral end of the turbine shell 331. For example, the turbine hub 333 is fixed to the turbine shell 331 by rivets. In the present preferred embodiment, the turbine hub 333 is provided as a different member separated from the turbine shell 331. However, the turbine hub 333 may be provided as a single member integrated with the turbine shell 331.

The output shaft 6 is attached to the turbine hub 333. When described in detail, the output shaft 6 is spline-coupled to the turbine hub 333. The turbine hub 333 is unitarily rotated with the output shaft 6.

The turbine hub 333 includes a third boss portion 333a and a third flange portion 333b. The third boss portion 333a and the third flange portion 333b are provided as a single member integrated with each other.

The third boss portion 333a has a cylindrical shape and includes a spline hole. The output shaft 6 is spline-coupled to the third boss portion 333a. The third boss portion 333a axially extends from the third flange portion 333b to the opposite side of the electric motor 2. In other words, the third boss portion 333a axially extends from the third flange portion 333b toward the cover hub 313.

The third boss portion 333a is disposed radially apart from the protruding portion 313c at an interval. In other words, the protruding portion 313c is disposed radially outside the third boss portion 333a. A bearing member 35 is disposed between the third boss portion 333a and the protruding portion 313c. It should be noted that without installation of the bearing member 35, the outer peripheral surface of the third boss portion 333a and the inner peripheral surface of the protruding portion 313c are opposed to each other.

A flow pathway is provided between the cover hub 313 and the distal end of the third boss portion 333a such that the hydraulic fluid flows therethrough. In the present preferred embodiment, the third boss portion 333a is provided with a plurality of cutouts 333c on the distal end thereof. The cutouts 333c radially extend on the distal end of the third boss portion 333a. The hydraulic fluid is discharged from the torque converter 3 through the cutouts 333c and the through holes 313d.

The third flange portion 333b extends radially outward from the third boss portion 333a. When described in detail, the third flange portion 333b extends radially outward from the electric motor 2-side end of the third boss portion 333a. The turbine shell 331 is fixed to the outer peripheral end of the third flange portion 333b by the rivets or so forth.

The stator 34 is configured to regulate the flow of the hydraulic oil returning from the turbine 33 to the impeller 32. The stator 34 is rotatable about the rotational axis O. For example, the stator 34 is supported by the stationary shaft 104 through the one-way clutch 36. The stator 34 is disposed axially between the impeller 32 and the turbine 33.

The stator 34 includes a stator carrier 341 having a disc shape and a plurality of stator blades 342 attached to the outer peripheral surface of the stator carrier 341.

The one-way clutch 36 is disposed between the stationary shaft 104 and the stator 34. The one-way clutch 36 is configured to make the stator 34 rotatable in the forward rotational direction. By contrast, the one-way clutch 36 makes the stator 34 non-rotatable in the reverse rotational direction. The power (torque) is transmitted from the impeller 32 to the turbine 33, while being amplified by the stator 34.

The centrifugal clutch 37 is attached to the turbine 33. The centrifugal clutch 37 is unitarily rotated with the turbine 33. The centrifugal clutch 37 is configured to couple the cover 31 and the turbine 33 to each other by a centrifugal force generated in rotation of the turbine 33. When described in detail, the centrifugal clutch 37 is configured to transmit the power from the cover 31 to the turbine 33 when the rotational speed of the turbine 33 becomes greater than or equal to a predetermined value.

The centrifugal clutch 37 includes a plurality of centrifugal elements 371 and a plurality of friction materials 372. The friction materials 372 are attached to the outer peripheral surfaces of the centrifugal elements 371. The centrifugal elements 371 are disposed to be radially movable. It should be noted that the centrifugal elements 371 are disposed to be circumferentially immovable.

Because of this, the centrifugal elements 371 are rotated together with the turbine 33 and are moved radially outward by centrifugal forces.

When the rotational speed of the turbine 33 becomes greater than or equal to the predetermined value, the centrifugal clutch 37 is configured such that the centrifugal elements 371 are moved radially outward and the friction materials 372 are engaged by friction with the inner peripheral surface of the cylindrical portion 312 of the cover 31. As a result, the centrifugal clutch 37 is turned to an on state, and the power inputted to the cover 31 is transmitted therefrom to the turbine 33 through the centrifugal clutch 37. It should be noted that even when the centrifugal clutch 37 is turned to the on state, the hydraulic fluid is capable of flowing through the centrifugal clutch 37.

When the rotational speed of the turbine 33 becomes less than the predetermined value, the centrifugal elements 371 are moved radially inward, whereby the friction materials 372 and the inner peripheral surface of the cylindrical portion 312 of the cover 31, engaged by friction, are disengaged from each other. As a result, the centrifugal clutch 37 is turned to an off state, and the power inputted to the cover 31 is not transmitted therefrom to the turbine 33 through the centrifugal clutch 37. In other words, the power inputted to the cover 31 is transmitted therefrom to the impeller 32 and is then transmitted to the turbine 33 through the hydraulic fluid.

### Input Shaft 5

As shown in FIGS. 1 and 3, the input shaft 5 extends from the electric motor 2. When described in detail, the input shaft 5 extends from the rotor 23 of the electric motor 2. The input shaft 5 extends toward the torque converter 3. The rotational axis of the input shaft 5 is substantially matched with that of the first electric motor 2 and that of the torque converter 3.

The input shaft 5 inputs the power, outputted from the electric motor 2, to the torque converter 3. The input shaft 5 is attached at the distal end thereof to the cover hub 313 of the torque converter 3. The input shaft 5 is unitarily rotated with the rotor 23 of the electric motor 2. The input shaft 5 extends through the interior of the output shaft 6. The input shaft 5 is solid. The input shaft 5 includes a communicating pathway 51 in the distal end thereof. The communicating pathway 51 extends in the axial direction. Besides, the communicating pathway 51 is opened toward the first cooling flow pathway 9a.

### Output Shaft 6

The output shaft 6 outputs the power inputted thereto from the torque converter 3. The output shaft 6 outputs the power, inputted thereto from the torque converter 3, to the power output part 4. The output shaft 6 extends from the torque converter 3 toward the electric motor 2.

The output shaft 6 has a cylindrical shape. The input shaft 5 extends through the interior of the output shaft 6. The output shaft 6 is attached at one end (the right end in FIG. 3) thereof to the turbine 33 of the torque converter 3. On the other hand, the output shaft 6 is rotatably supported at the other end, for instance, by the transmission casing 40 through a bearing member and/or so forth.

### Power Output Part 4

As shown in FIG. 1, the power output part 4 is disposed axially between the electric motor 2 and the torque converter 3. The power output part 4 is accommodated in the interior of the transmission casing 40. The power output part 4 outputs the power, inputted thereto from the torque converter 3, toward the drive wheels 101. When described in detail, the power output part 4 outputs the power, inputted thereto from the torque converter 3, to the drive wheels 101 through a differential gear 109. It should be noted that as described below, the power output part 4 does not output the power in a neutral mode.

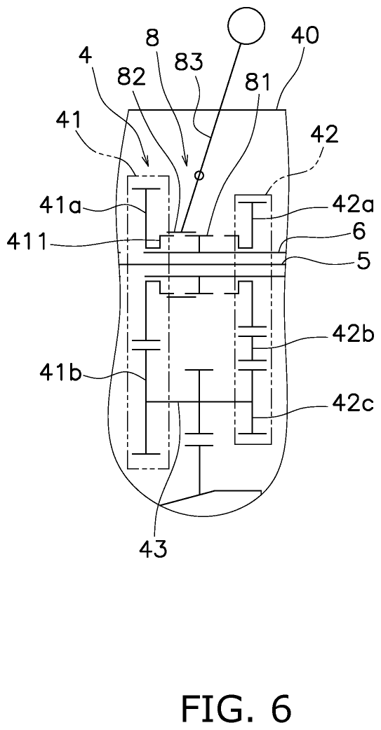

As shown in FIG. 6, the power output part 4 includes a first gear train 41 and a second gear train 42. The power output part 4 outputs the power therefrom through either the first gear train 41 or the second gear train 42. The first gear train 41 outputs the power, inputted to the power output part 4 from the torque converter 3, in a first rotational direction. The second gear train 42 outputs the power, inputted to the power output part 4 from the torque converter 3, in a second rotational direction. The second rotational direction is a rotational direction reverse to the first rotational direction.

The first rotational direction is a rotational direction corresponding to forward movement of the vehicle. The second rotational direction is a rotational direction corresponding to backward movement of the vehicle. Because of this, when the power is transmitted to the drive wheels 101 through the first gear train 41, the vehicle is moved forward. By contrast, when the power is transmitted to the drive wheels 101 through the second gear train 42, the vehicle is moved backward.

The first gear train 41 includes a first gear 41a and a second gear 41b that are meshed with each other. The first gear 41a is supported by the output shaft 6, while being rotatable relative thereto. When a ring gear 82 of the switch mechanism 8 (to be described) is meshed with the first gear 41a, the first gear 41a is unitarily rotated with the output shaft 6.

The second gear 41b is supported by a drive shaft 43. The second gear 41b is unitarily rotated with the drive shaft 43. The second gear 41b outputs the power, inputted thereto from the first gear 41a, to the drive shaft 43.

The second gear train 42 includes a third gear 42a, a fourth gear 42b, and a fifth gear 42c. The number of gears in the second gear train 42 is greater by one than that in the first gear train 41. The third gear 42a is supported by the output shaft 6, while being rotatable relative thereto. When the ring gear 82 of the switch mechanism 8 (to be described) is meshed with the third gear 42a, the third gear 42a is unitarily rotated with the output shaft 6.

The fourth gear 42b is meshed with the third gear 42a. The fourth gear 42b is supported by a countershaft (not shown in the drawings). The fourth gear 42b may be rotated unitarily with or relative to the countershaft.

The fifth gear 42c is meshed with the fourth gear 42b. The fifth gear 42c is supported by the drive shaft 43. The fifth gear 42c is unitarily rotated with the drive shaft 43. The fifth gear 42c outputs the power, inputted thereto from the third gear 42a, to the drive shaft 43.

The first gear train 41 has a different gear ratio from the second gear train 42. When described in detail, the second gear train 42 has a higher gear ratio than the first gear train 41.

The power output part 4 can be set to any of a first output mode, a second output mode, and a neutral mode. When in the first output mode, the power output part 4 outputs the power through the first gear train 41. By contrast, when in the second output mode, the power output part 4 outputs the power through the second gear train 42. On the other hand, when in the neutral mode, the power output part 4 does not output the power inputted thereto from the torque converter 3.

### Switch Mechanism 8

The switch mechanism 8 is configured to switch the power output part 4 from one to another among the first output mode, the second output mode, and the neutral mode. The switch mechanism 8 includes a clutch hub 81, the ring gear 82, and a lever 83.

The clutch hub 81 is attached to the output shaft 6. The clutch hub 81 is unitarily rotated with the output shaft 6. The clutch hub 81 may be provided as a single member integrated with the output shaft 6, or alternatively, may be provided as a different member separated from the output shaft 6. The clutch hub 81 includes a plurality of teeth on the outer peripheral surface thereof

The ring gear 82 includes a plurality of teeth on the inner peripheral surface thereof. The ring gear 82 is constantly meshed with the clutch hub 81 and is unitarily rotated therewith. In other words, the ring gear 82 is unitarily rotated with the output shaft 6. The ring gear 82 is disposed to be movable in the axial direction.

As shown in FIG. 6, the ring gear 82 is meshed with the clutch hub 81 and is also capable of being turned to a state of engagement with the first gear 41a. When described in detail, the first gear 41a includes a first cylindrical portion 411 protruding in the axial direction. The first cylindrical portion 411 includes a plurality of teeth on the outer peripheral surface thereof. The ring gear 82 is herein meshed with the outer peripheral surface of the first cylindrical portion 411.

When the ring gear 82 is meshed with the clutch hub 81 and the first cylindrical portion 411 as described above, the power output part 4 is set to the first output mode. In other words, the power, inputted to the power output part 4 from the output shaft 6, is outputted through the first gear train 41.

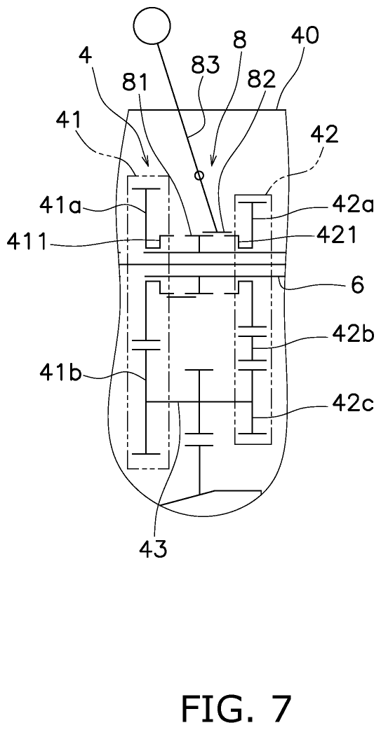

As shown in FIG. 7, the ring gear 82 is meshed with the clutch hub 81 and is also capable of being turned to a state of engagement with the third gear 42a. When described in detail, the third gear 42a includes a second cylindrical portion 421 protruding in the axial direction. The second cylindrical portion 421 includes a plurality of teeth on the outer peripheral surface thereof. The ring gear 82 is herein meshed with the outer peripheral surface of the second cylindrical portion 421.

When the ring gear 82 is meshed with the clutch hub 81 and the second cylindrical portion 421 as described above, the power output part 4 is set to the second output mode. In other words, the power, inputted to the power output part 4 from the output shaft 6, is outputted through the second gear train 42.

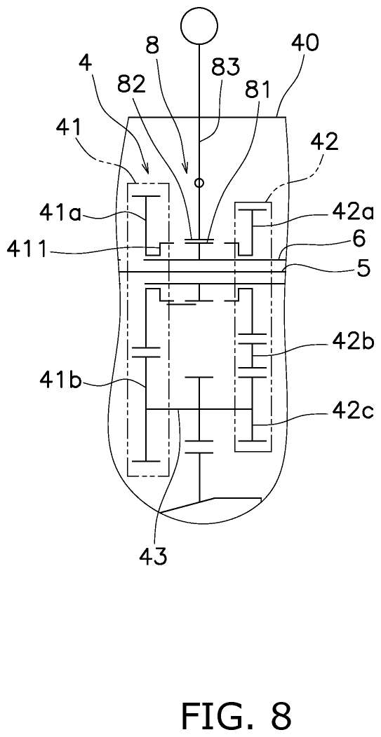

As shown in FIG. 8, the ring gear 82 is capable of being turned to a state of meshing with only the clutch hub 81. When the ring gear 82 is meshed with only the clutch hub 81 without being meshed with both the first and second cylindrical portions 411 and 421 as described above, the power output part 4 is set to the neutral mode. In other words, the power, inputted to the power output part 4 from the output shaft 6, is not outputted toward the drive wheels 101.

The lever 83 is coupled to the ring gear 82. The lever 83 extends from the ring gear 82 to the outside of the transmission casing 40. The lever 83 is operated by a driver. The ring gear 82 is axially movable in conjunction with operating the lever 83. The axial movement of the ring gear 82 results in meshing with the clutch hub 81 and the first cylindrical portion 411, meshing with the clutch hub 81 and the second cylindrical portion 421, or meshing with only the clutch hub 81. As a result, the switch mechanism 8 enables the power output part 4 to be switched from one to another among the first output mode, the second output mode, and the neutral mode.

### Torque Converter Casing 7

As shown in FIG. 9, the torque converter casing 7 accommodates the torque converter 3. In the present preferred embodiment, the torque converter casing 7 is provided as a single member integrated with the transmission casing 40. However, the torque converter casing 7 may be provided as a different member separated from the transmission casing 40.

The torque converter casing 7 includes a sidewall portion 71, an outer wall portion 72, and a plurality of heat dissipation fins 73. The sidewall portion 71 is disposed opposite to the cover 31 of the torque converter 3. The sidewall portion 71 is disposed orthogonal to the rotational axis O.

The torque converter 3 is disposed on one side (the left side in FIG. 9) of the sidewall portion 71 in the axial direction. On the other hand, the sidewall portion 71 contacts external air at the other side thereof (the right lateral surface in FIG. 9). In other words, such a member as functioning as a heat source is not disposed on the other side of the sidewall portion 71.

The cover 31 is rotatably attached to the middle part of the sidewall portion 71 through the bearing member 102. The sidewall portion 71 is made of a material, having a high specific heat and a high thermal conductivity, so as to quickly absorb a large amount of heat from the hydraulic fluid flowing through the first cooling flow pathway 9a and release the absorbed heat to the atmosphere. For example, the sidewall portion 71 is made of magnesium, aluminum, or so forth.

The outer wall portion 72 is disposed opposite to the outer peripheral surface of the torque converter 3. The outer wall portion 72 is provided as a single member integrated with the sidewall portion 71. However, the outer wall portion 72 may be provided as a different member separated from the sidewall portion 71. The outer wall portion 72 extends toward the electric motor 2 from the outer peripheral end of the sidewall portion 71. The outer wall portion 72 extends substantially in parallel to the rotational axis O. It should be noted that the distal end (the electric motor 2-side end) of the outer wall portion 72 slants radially inward. The outer wall portion 72 can be made of a similar material to the sidewall portion 71.

The heat dissipation fins 73 are provided on the sidewall portion 71. The heat dissipation fins 73 extend from the sidewall portion 71 to the opposite side (rightward in FIG. 9) of the torque converter 3. The heat dissipation fins 73 are attached to the sidewall portion 71 in order to efficiently dissipate the heat of the hydraulic fluid flowing through the first cooling flow pathway 9a. The thermal conductivity of the heat dissipation fins 73 is preferably set to be equivalent to or higher than that of the sidewall portion 71 but is not particularly limited to this setting. The heat dissipation fins 73 are made of, for instance, magnesium, aluminum, copper, or so forth.

### First Cooling Flow Pathway 9a

The first cooling flow pathway 9a is a flow pathway for cooling the hydraulic fluid discharged from the torque converter 3. The first cooling flow pathway 9a extends in the interior of the torque converter casing 7. In the present preferred embodiment, the first cooling flow pathway 9a is provided only in the upper half of the torque converter casing 7.

The first cooling flow pathway 9a extends from the middle part to the outer peripheral part in the interior of the sidewall portion 71 and axially extends therefrom beyond the torque converter 3 in the interior of the outer wall portion 72. The first cooling flow pathway 9a is communicated with a hydraulic fluid sump 91.

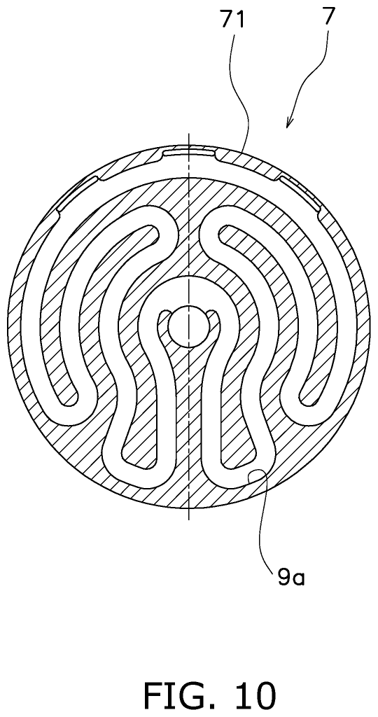

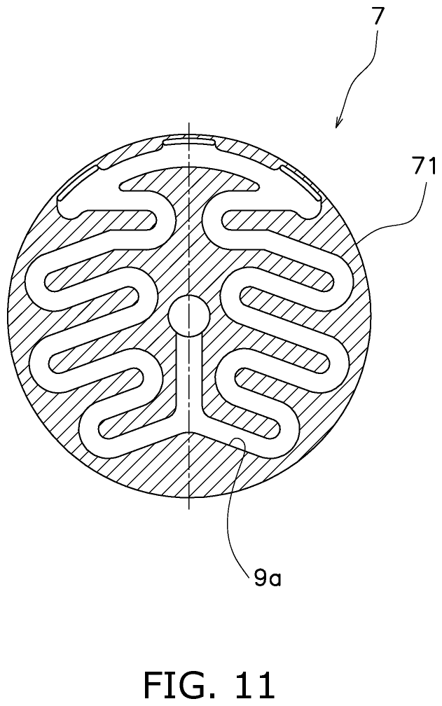

As shown in FIG. 10 or FIG. 11, the first cooling flow pathway 9a includes a plurality of paths in the interior of the sidewall portion 71. In the present preferred embodiment, the first cooling flow pathway 9a is divided into two paths in the interior of the sidewall portion 71. In the interior of the sidewall portion 71, the first cooling flow pathway 9a extends from the middle part to the outer peripheral part not in a straight shape but in a winding shape.

The first cooling flow pathway 9a may include a plurality of paths in the interior of the outer wall portion 72 as well. In the present preferred embodiment, the first cooling flow pathway 9a is divided into, for instance, three paths in the interior of the outer wall portion 72. The first cooling flow pathway 9a axially extends in a straight shape in the interior of the outer wall portion 72. Alternatively, the first cooling flow pathway 9a may extend in a winding shape in the interior of the outer wall portion 72.

### Hydraulic Fluid Sump 91

As shown in FIG. 9, the drive unit 100 includes the hydraulic fluid sump 91. The hydraulic fluid sump 91 is disposed to axially interpose the torque converter 3 in cooperation with the sidewall portion 71 therebetween. In other words, the hydraulic fluid sump 91, the torque converter 3, and the sidewall portion 71 are axially aligned in this order. The hydraulic fluid sump 91 is disposed in the interior of the transmission casing 40. The hydraulic fluid sump 91 is disposed above the rotational axis O.

The hydraulic fluid sump 91 contains the hydraulic fluid to be supplied to the torque converter 3 in the interior thereof. The hydraulic fluid sump 91 is provided with a supply port 92 in the bottom surface thereof. The hydraulic fluid, discharged from the supply port 92, is supplied to the torque converter 3 through a flow pathway 106 provided between the stationary shaft 104 and the second boss portion 323a of the impeller hub 323.

Specifically, a centrifugal force is generated in rotation of the impeller 32 of the torque converter 3, whereby the hydraulic fluid residing in the interior of the flow pathway 106 is supplied to the interior of the torus T through the supply flow pathways 324. Then, the hydraulic fluid, discharged from the torque converter 3, flows to the first cooling flow pathway 9a through the communicating pathway 51. Subsequently, the hydraulic fluid, cooled while flowing through the first cooling flow pathway 9a, is returned to the hydraulic fluid sump 91.

### Actions

In the drive unit 100 configured as described above, the power output part 4 is set to the first output mode in forward movement of the vehicle. As a result, the power, inputted to the torque converter 3 from the electric motor 2, is outputted to the drive wheels 101 through the first gear train 41 of the power output part 4. By contrast, the power output part 4 is set to the second output mode in backward movement of the vehicle. As a result, the power, inputted to the torque converter 3 from the electric motor 2, is outputted to the drive wheels 101 through the second gear train 42 of the power output part 4. Thus, the rotational direction of the electric motor 2 and that of the torque converter 3 remain unchanged regardless of forward movement and backward movement of the vehicle. Because of this, the drive unit 100 can amplify a torque not only in forward movement but also in backward movement.

### Modifications

One preferred embodiment of the present invention has been explained above. However, the present invention is not limited to the above, and a variety of changes can be made without departing from the gist of the present invention.

### Modification 1

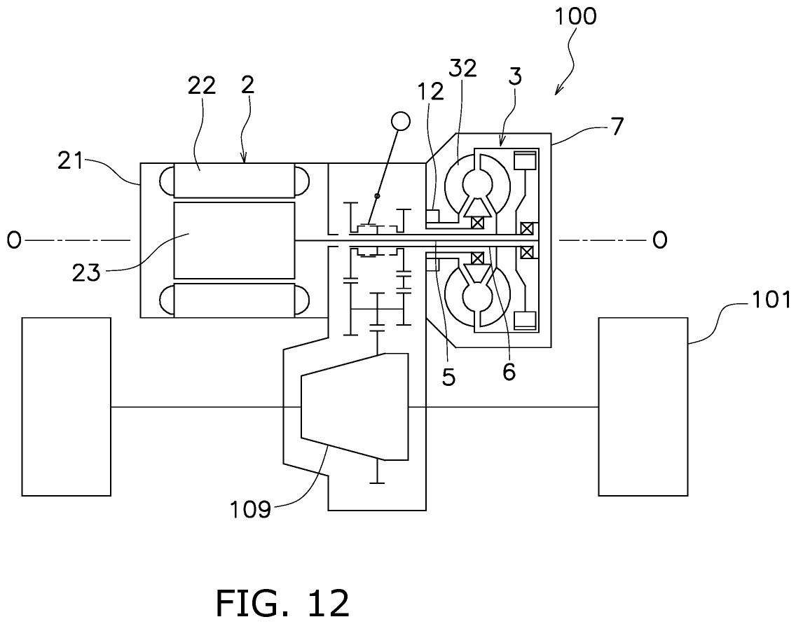

In the preferred embodiment described above, the impeller 32 includes the supply flow pathways 324. However, the configuration of the impeller 32 is not limited to this. In other words, the impeller 32 may not include the supply flow pathways 324. In this case, the drive unit 100 may further include an oil pump 12 as shown in FIG. 12.

The oil pump 12 is configured to supply oil to the interior of the torque converter 3. The oil pump 12 is unitarily rotated with either the electric motor 2 or the torque converter 3. When described in detail, the oil pump 12 is attached to the impeller 32, while being unitarily rotated therewith. In more detail, the oil pump 12 is attached to the impeller hub 323 of the impeller 32. The oil pump 12 is, for instance, a displacement pump.

### Modification 2

In the preferred embodiment described above, the switch mechanism 8 switches the power output part 4 among the modes in conjunction with operating the lever 83. However, the configuration of the switch mechanism 8 is not limited to this. For example, the switch mechanism 8 can be also configured to switch the power output part 4 among the modes by electronic control or so forth.

### Modification 3

The electric motor 2 may be a synchronous motor. In this case, characteristics similar to those of the electric motor 2 in the preferred embodiment described above can be obtained by controlling electric current flowing through the coil of the stator 22 of the electric motor 2.

### REFERENCE SIGNS LIST

2 Electric motor
22 Stator
23 Rotor
3 Torque converter
100 Drive unit

What is claimed is:

1. A drive unit comprising:
a torque converter; and
an electric motor configured to drive a drive wheel through the torque converter, wherein
the electric motor has a characteristic that an output torque increases with increase in rotational speed within a rotational speed range from stoppage to a predetermined rotational speed.

2. The drive unit according to claim 1, wherein the electric motor has a characteristic that the output torque reduces with increase in rotational speed within a higher rotational speed range than the predetermined rotational speed.

3. The drive unit according to claim 1, wherein the electric motor includes a magnet-free rotor and a stator.
